(19) United States
(12) Patent Application Publication
(10) Pub. No.: US 2012/0135208 A1
(43) Pub. Date: May 31, 2012

(54) Adhesive Marking Device Comprising A Carrier Film And Method For Marking Such Device

(75) Inventor: Jean-Michel Hillereau, Lons (FR)

(73) Assignee: ADHETEC, Tarbes (FR)

(21) Appl. No.: 13/378,064

(22) PCT Filed: Mar. 10, 2010
(86) PCT No.: PCT/FR2010/050404

§ 371 Date: Feb. 16, 2012

(30) Foreign Application Priority Data
Mar. 11, 2009 (FR) 09.01119

(51) Int. Cl. B32B 3/00; B32B 38/04; B32B 38/14; B32B 37/12

(52) U.S. Cl. 428/203; 156/250

(57) ABSTRACT

An adhesive marking device (1) includes a carrier film (2) made of a synthetic material and carrying on a first surface, referred to as an upper surface, at least one marking pattern (5) covered with a varnish protection layer (6) and on a second surface opposite to the first one, referred to as a lower surface, a pressure-sensitive adhesive layer (3) protected by a protection sheet (4), characterized in that the carrier film (2) is a polyester film having a thickness of between 20 and 50 μm and has two surfaces with a roughened surface state. A method for making such a marking device is also described.

The invention relates to an adhesive marking device, for example for affixing information or decorative elements to both the outside and inside of flat or complex surfaces such as vehicle bodies, and more particularly to vehicles such as trains, aircraft, etc. The invention further relates to a process for the production of such a marking device.

In the remainder of the present description, an aircraft will be used as an example of the use of the device, without implying a limitation and without excluding any other type of vehicle, vehicle body or surface to which the marking device according to the invention could be affixed.

Numerous markings have to be affixed in and to aircraft. These markings can be informative, using text and/or pictograms, or decorative, for example the airlines' logos, some of which use colored pictures or photographs. These markings, particularly those relating to safety, have to possess strength and stability over time and to attack by external agents (chemical, climatic, mechanical, etc.), placing numerous constraints on the marking processes employed. The techniques of painting directly or with stencils are suitable for large patterns with few colors, but for patterns that demand a high resolution and/or a variety of colors, such as photographs, the adhesive label and the transfer are still unavoidable solutions.

Document WO2007/021550, for example, discloses marking devices of the label or transfer type which are suitable for aircraft marking. The distinction between a label and a transfer is that in the case of a label the marking pattern is made on top of a carrier film (which has a layer of glue on the bottom for transferring the device to a substrate), whereas in the case of a transfer the marking is made between the carrier film and the layer of glue.

The adhesive label proposed by the document cited above consists of a polymer carrier film carrying a marking pattern on one side and a layer of pressure-sensitive glue on the other. For the label to be able to have the desired strength, the document states that these three layers must be chemically compatible with one another and with the covering on the substrate to which the label is to be affixed, as well as with a varnish that covers the label and the substrate with a continuous layer. As a result of this compatibility demand, particularly between the inks or paints forming the marking pattern and the carrier film, “systems” are produced in which each manufacturer proposes its own carrier film and the associated marking inks. It should be noted that, particularly for transparent labels, the smooth, polished surface of the carrier film that is necessitated by the glossiness and transparency of the label has to be coated with a finishing layer, again compatible, to enable the inks to adhere.

It is therefore understood that the label manufacturer, who often works in small production runs, particularly in the aeronautical industry, is thus confined by the manufacturers of the carrier films and associated ink systems. It is for this reason that some technical demands cannot be met for lack of a suitable “system” that meets all these demands. For example, such a manufacturer of transparent carrier film will supply it in vinyl, which is sensitive to ultraviolet radiation, whereas another, who supplies a resistant polyester film, will have an ink system which is incompatible with the chemicals employed in the label's environment (for example kerosene or SKYDROL® in the aeronautical industry, and so on).

Moreover, the impossibility of using the inks from a manufacturer X with the film from a manufacturer Y because of different finishes that are often chemically incompatible leads to quality and stock management problems if they become mixed.

One object of the invention is therefore to propose an adhesive marking device that makes it possible to meet various demands without having to use multiple “systems” of carrier films and associated inks.

Another object of the invention is to provide such a marking device whose carrier film is compatible with a wide variety of inks and/or paints and of processes for applying them.

Another object of the invention is to provide such a marking device which has a reduced manufacturing cost and whose manufacturing process is simplified compared with the known labels.

The invention further relates to a marking device which can be used on a wide variety of smooth or textured substrates.

The invention further relates to a marking device which can be produced using the same paints as those employed for the substrate (for example airplane fuselage) to which the marking device may be affixed, so as to replace the adhesive decorations produced with bulk-dyed films, which show sometimes appreciable differences in shade from the aforementioned paints.

The invention further relates to a marking device which makes it possible to produce unique artistic decorations without requiring the immobilization of the object (for example airplane) to which the decoration is to be affixed.

To do this, the invention relates to an adhesive marking device comprising a synthetic carrier film carrying on a first side, called the upper side, at least one marking pattern covered with a layer of protective varnish, and on a second side opposite the first, called the lower side, a layer of pressure-sensitive adhesive protected by a protective sheet, wherein the carrier film is a polyester film having a thickness of between 20 and 50 μm, both sides of which have a dulled surface condition whose roughness is appropriate for obtaining a surface energy of at least 58 mN/m according to standard ASTM D2578.

It should be noted that, in the following description, the terms “top”, “bottom”, upper, lower and the like are used to define the relative order of the different layers or films constituting the marking device according to the invention, and/or their respective sides, by reference to an axis normal to the surface of the substrate to which the marking device is to be affixed, and oriented away from the substrate and towards the exterior of the marking device.

The dulling, whether produced by mechanical scratching or brushing of the surface of the film or, preferably, by chemical attack, increases the roughness of the surface of the carrier film, removes the smooth, polished appearance of the crude film obtained by calendering or casting, improves the wettability and affords a good adhesion between the marking inks of various types and origins and the surface of the film without requiring a finishing layer or chemical compatibility. This surface condition, which has the secondary effect of dulling the surface of the film and gives it a milky appearance when the film is transparent, appears to contradict the desired aim, which is to obtain a marking device with a high glossiness and a very high transparency. The inventors nevertheless found that, surprisingly, the subsequent application of a transparent varnish to the upper side of the film made it possible not only to restore glossiness to the marking device, but also, in combination with a layer of transparent adhesive applied to the lower side of the film, to restore perfect transparency to the marking device.

Advantageously and according to the invention, the carrier film is a transparent film of polyethylene terephthalate (PET) having a thickness of between 20 and 30 μm. Such a material, hitherto difficult to use because of the poor stability of inks and paints on its surface, now makes it possible to satisfy environmental stability demands which transparent vinyl films could not meet, and simultaneously offers a resistance to UV radiation beyond the capability of the polyesters normally employed.

Advantageously and according to the invention, the marking device comprises a layer of pressure-sensitive adhesive whose thickness is between one and three times that of the carrier film, the minimum thickness being 50 μm. Such a thickness of glue, which is greater than that commonly encountered in self-adhesive labels, has numerous advantages. These include an improved stiffness of the carrier film/glue/protective film composite, enabling it to be used in vacuum table screen printing without deformation, a better adhesive strength, and a better compensation of the differential expansions between the substrate and the marking device when the latter is affixed to its substrate, without thereby incurring risks of loss of cohesion between the glue and the carrier film by virtue of the enhanced adhesion capacity offered by the dulled surface of the lower side of the carrier film.

Advantageously and according to the invention, the layer of pressure-sensitive adhesive has a thickness of at least 100 μm, which is suitable for sticking said marking device to textured surfaces. It is thus possible easily and reliably to affix the marking device to surfaces such as embossed panels forming the inner walls of the aircraft cabin, or carbon-fiber inner walls of the engine pods, whereas previously it was necessary to affix markings to screwed or riveted metal labels.

Advantageously and according to the invention, the carrier film carries on its upper side a marking pattern in direct contact with said film. By virtue of the roughness of the dulled carrier film and the high surface energy it allows, it is no longer necessary to place a layer of high grab primer between the carrier film and the ink applied to the film.

Moreover, the minimum adhesion between the marking pattern and the carrier film is at least 2.6 MPa according to standard ISO 4624. In fact, the roughness of the carrier film obtained by the dulled surface condition makes it possible not only to increase the wettability of the carrier, but also to enhance the adhesion capacity of the inks and varnishes deposited thereon.

Advantageously and according to the invention, the marking pattern and the upper side of the carrier film are covered with a layer of protective varnish, optically smoothing the upper side of the carrier film and acting technically as an interface with the external medium. Applying at least one layer of varnish on top of the marking pattern, and particularly between the elements of the pattern, directly on the upper side of the carrier film, makes it possible to block the pores or micro-scratches on said side, giving it the glossy appearance of a smooth cast or calendered film of the prior art.

Advantageously and according to the invention, when the marking device is suitable for application to a substrate which is to be covered with a finish after application, the protective varnish forming said layer is compatible with this finish. The varnish has an improved adhesion to the dulled upper side of the carrier film, making it possible directly to use a varnish that is compatible with the paints and coverings used for the substrate to which the marking device is to be affixed. Therefore, for affixing markings to an airplane fuselage, for example, it is possible to stick the marking device on and cover it at the same time as the fuselage with a finishing varnish approved by the airplane manufacturers and/or the airlines.

Advantageously and according to the invention, the protective varnish is selected from a range of compositions which ensure, individually or in combination, that the external surface of the marking device has mechanical and/or chemical properties of resistance to graffiti, soil, scratching, abrasion, impact and chemicals, and/or antiskid properties. By virtue of the wettability and adhesion properties imparted by the dulled surface of the carrier film, it is now possible to use numerous varnish and transparent paint compositions which are capable of imparting these properties to the marking device, but which hitherto were incompatible with the known carrier films. The laminating films employed to date, which are expensive and difficult to use, are thus advantageously replaced.

Advantageously and according to the invention, when the marking device is suitable for application to a substrate which is to be covered with a finish after application, the outer side of the layer of protective varnish has a surface condition that is appropriate for facilitating the adhesion of the finish to the marking device. For example, the outer side of the layer of protective varnish has a dullness with properties analogous to those of the dullness of the carrier film so that the substrate and the marking device can be covered with the finish without discontinuities.

Advantageously and according to the invention, when the marking device is suitable for application to a substrate covered with a paint, the carrier film is covered with an identical paint. Having self-adhesive film surfaces covered with the same paint as that used to paint all or part of an airplane fuselage makes it possible to produce self-adhesive decorations whose shade is identical to that of the chosen paint, in contrast to the bulk-dyed films used hitherto, where the choices were limited by their restricted range. Moreover, it is now possible to paint a unique artistic decoration on a vehicle or any other substrate without having to immobilize it while the work is being carried out. By virtue of the marking device of the invention, the work is carried out on a surface of the carrier film and then transferred to the vehicle.

Advantageously and according to the invention, the marking device also comprises a weakly adhesive handling film stuck to its upper side. Such a handling film, generally made of paper or transparent or semitransparent polyethylene coated with a rubber adhesive of low adhesive strength that does not leave a residue on the external surface of the marking device, makes it possible to affix the latter with precision.

The invention also relates to a process for the production of a marking device having at least one of the characteristics mentioned above, wherein:
the chosen carrier film is a polyester film having a thickness of between 20 and 50 μm, both sides of which have a dulled surface condition whose roughness is appropriate for obtaining a surface energy of at least 58 mN/m according to standard ASTM D2578,
a layer of adhesive is applied to the lower side of the carrier film,
a marking pattern is printed on the upper side of said carrier film,
the marking pattern and the parts of the carrier film that are not covered by it are covered with a layer of varnish,
the outline of the marking device is cut, and
the varnish is covered with a transparent handling film.

In the process of the invention, the layer of glue applied to the dulled polyester film can be applied by the manufacturer of the carrier film if minimal quantities are ordered, but it can also be applied by the manufacturer of the marking device in the case of smaller surfaces, thus enabling the manufacturer of the marking device to choose the glue which, in terms of its thickness, nature and adhesive strength, is appropriate for the application envisaged. Such a process is therefore more flexible and more adaptable to requirements.

Advantageously and according to the invention, the layer of glue is applied by colaminating a film of acrylic glue and the dulled carrier film. Preferably, depending on the nature and thickness of the film of glue, the lamination is carried out hot. In particular, and still according to the invention, when the carrier film is transparent, the lamination is carried out in a dust-free, controlled atmosphere.

Advantageously and according to the invention, the marking pattern is printed by digital inkjet printing. It is thus possible, even for small production runs or even for single items, to produce monochrome or polychrome labels, if necessary of photographic quality, from a definition in the form of a digital file.

Alternately and according to the invention, the marking pattern is printed by screen printing. For larger production runs, the same carrier film can be used with screen printing inks of various origins and it was found that, surprisingly, the patterns produced in this way had a greatly reduced drying time compared with the same patterns produced by screen printing on smooth-surface films of the prior art.

Advantageously and according to the invention, the step for covering the marking pattern and the carrier film with a layer of varnish is carried out by screen printing.

Alternately and according to the invention, the step for covering the marking pattern and the carrier film with a layer of varnish is carried out by spraying.

Advantageously and according to the invention, a step for treating the external surface of the layer of varnish is inserted before the step for covering the varnish with a handling film. This surface treatment can be effected by mechanical or chemical dulling of the upper side of the varnish, or else by cleaning with a solvent, in order to promote the adhesion of a subsequent finishing layer to the marking device.

The user can thus omit the customary surface preparation operations at the time when the marking device is transferred and then varnished on the carrier.

As these operations were performed during the manufacture of the marking device, they are no longer necessary when the latter is used, making its use more economic.

The invention further relates to a marking device and to a process for the production of said device, characterized by a combination of all or some of the characteristics mentioned above or below.

Other aims, characteristics and advantages of the invention will become apparent from the description which follows and from the attached drawings, in which:

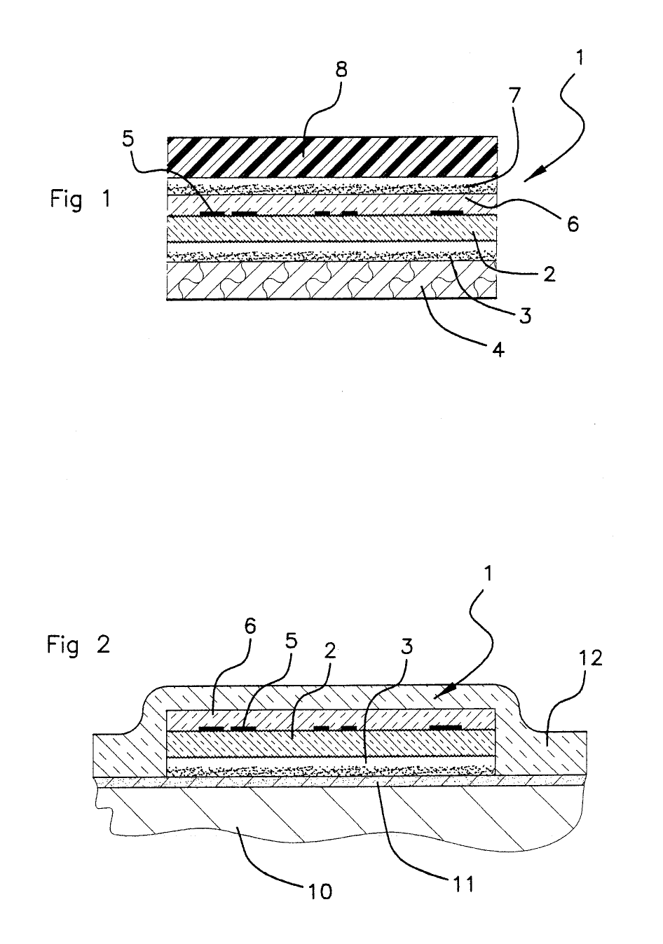

FIG. 1 is a diagrammatic cutaway view of a marking device according to the invention before it is affixed to a substrate,

FIG. 2 is a diagrammatic cutaway view of the same marking device according to the invention after it has been affixed to a substrate and the latter has been protected, and

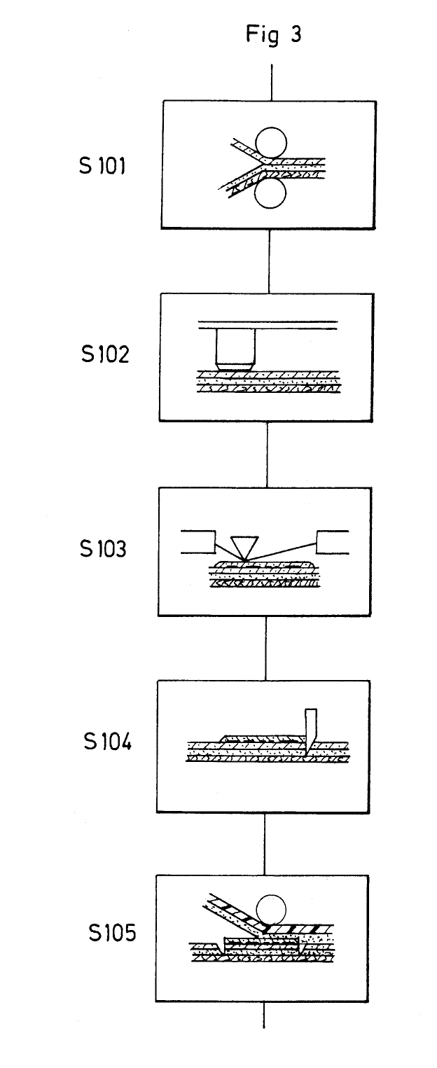

FIG. 3 is a diagrammatic view of the successive steps of the process for the production of a marking device according to the invention.

For illustrative purposes, scales are not respected in the Figures; in particular, the thicknesses are unduly enlarged.

The marking device 1 shown in section in FIG. 1 comprises a polymer carrier film 2, more particularly a polyester film having a thickness of between 20 and 50 μm, in the middle. The carrier film 2 can consist of polyester containing a pigment that renders it opaque, for example a titanium oxide (TiO₂) filler to give a white opaque carrier film, or alternately of polyethylene terephthalate (PET), which has the advantage of being transparent, having a high clarity and being very resistant to ultraviolet radiation.

The carrier film 2 has undergone a surface treatment on both sides that consists in a dulling of its surface by mechanical or chemical means. For example, the carrier film may have been subjected to mechanical brushing with abrasive straps, in one or both directions, so as to create an array of microscopic scratches on the surface of the film. Alternately, and preferably, the dulling can be effected by chemical means, for example by bathing or sprinkling the carrier film 2 with acids or other products suitable for attacking the surface of the film to a very small depth in the order of a few fractions of a micron. Chemical dulling is preferred as it carries a lower risk of leaving residues (particles of abrasive) included in the surface of the film or stuck on top, which could jeopardize the subsequent operations.

The carrier film 2 is bonded on its lower side to a layer of cold pressure-sensitive adhesive 3 (‘cold’ denoting ‘at room temperature’). For example, it is advantageously possible to use an ultraviolet-resistant, transparent adhesive composition of the acrylic type. The composition and thickness of this layer of adhesive 3 are chosen according to the application and particularly the nature and characteristics (especially condition) of the surface of the substrate 10 or of its covering 11 to which the marking device is to be affixed.

In general, the thickness of the layer of adhesive 3 is at least equal to that of the carrier film 2 and generally in the order of one to three times this thickness, the minimum being 50 μm. This thickness makes it possible to improve the adhesion of the marking device to a metallic substrate, for example, and to compensate more easily for variations in relative size between the marking device and the substrate it covers when there are large temperature variations such as those experienced by an airplane, namely between −50° C. in flight and +50° C. when parked on the ground.

In certain particular uses of the marking device according to the invention, it may be necessary to increase the thickness of the layer of glue 3, for example up to 100 μm or more, in order to allow for a textured condition of the substrate surface, an example being the embossed walls inside an airplane or the internal surfaces of the engine pods, which are made of carbon fibers. By virtue of the large thickness of the layer of glue 3, the latter can flow around the roughnesses on the substrate and fill the troughs, thereby enabling the marking device to adhere.

The layer of adhesive 3 is covered with a protective sheet 4, for example made of siliconized paper, which can easily be removed before the marking device is used. The layer of adhesive 3 can be transferred to the carrier film 2 immediately after the latter has been dulled by the manufacturer of the carrier film, if there is a need for large quantities of carrier film provided with a predetermined type of adhesive. The layer of adhesive 3 can also be transferred to the carrier film 2 at the time of manufacture of the marking device, by colamination of the carrier film 2 and a film of acrylic glue corresponding to the specifications of the marking device, as shown in step S101 of the process for the production of the marking device illustrated in FIG. 3. The film of acrylic glue is held on a sheet of siliconized paper and applied to the carrier film 2 by the laminating rolls.

In particular, when the carrier film 2 is a transparent film, this lamination step takes place in a so-called white or gray room, i.e. in a controlled environment with a reduced level of dust and particles suspended in the air so that they are not trapped between the carrier film 2 and the layer of adhesive 3. The lamination of the film of glue on the carrier film is carried out at room temperature or alternately under the action of heat to improve the interpenetration. It was noted that the lamination and particularly the hot lamination of the layer of adhesive 3 on the carrier film 2 afforded a close bond through penetration of the glue into the microroughnesses on the surface of the carrier film, and hence that the risks of loss of cohesion between the layer of adhesive 3 and the carrier film 2 were substantially reduced. Moreover, for a transparent adhesive and carrier film, this inter-penetration makes it possible to restore clarity to the interface between the carrier film 2 and the layer of adhesive 3.

The colamination of the carrier film and the layer of adhesive in the first steps of the manufacture of the marking device also makes it possible, taking into account the relative stiffness of the sheet 4 for protecting the layer of adhesive, to obtain a “composite” (carrier film, layer of adhesive, protective sheet) in the form of a sheet that is sufficiently stiff to be handled and, in particular, to be fixed by vacuum on printing or screen printing tables without being deformed or marked.

In the next step, S102, of the process for the production of the marking device, a marking pattern 5 is printed on the upper side of the carrier film. By virtue of the dulled surface condition of the carrier film 2, which has a degree of roughness, numerous inks can cover this surface without leaving residues in the way they do on smooth surfaces. It is therefore no longer necessary to use inks that are specially adapted to one or other type of carrier film and would not be suitable for different film transfer processes.

In particular, it is now possible to use a wide range of inks that are suitable for marking by digital inkjet printing. This marking technique is particularly suitable for small label production runs, or even single items, since it does not require special tools. Moreover, digital printing makes it possible to produce photographic types of marking pattern. In this technique a print head moves over the upper side of the carrier film 2 and, via a number of individually controlled nozzles, squirts droplets of colored ink(s) to form the desired marking pattern.

For larger label production runs, or those with a more restricted color range, screen printing is still a very economic marking technique. In this technique as well, the use of a carrier film 2 with a dulled surface enables a wide variety of screen printing inks to be employed without necessarily having to match the ink systems to the type of carrier film. This makes it possible to reduce the number of standard inks in stock and minimize the costs involved when a large number of them exceed their use-by date. It was also noted that, irrespective of the origin of the inks used, their covering power was improved and their drying time reduced. For example, whereas a drying time between layers in the order of 72 hours was required for an ink applied to a smooth carrier film used hitherto, the drying time was reduced to less than one hour for printing on the dulled carrier film of the invention.

Whatever the marking technique used, the marking pattern 5 transferred to the upper side of the carrier film 2 can be continuous or discontinuous, i.e. some parts of the surface of the carrier film may not be covered with ink, as in the case of information markings consisting of text or symbols on a white or transparent background.

In the next step (S103) of the process for the production of the marking device, a layer of transparent varnish 6 is deposited over the whole surface of the marking device. The layer of varnish 6 therefore covers the marking pattern 5 and that part of the upper side of the carrier film 2 which is not covered by the pattern 5. The varnish used is e.g. one that is compatible with a covering which is intended to cover the surface to which the marking device is affixed. For example, as illustrated in FIG. 2, the marking device 1 can be affixed to the external surface of an airplane fuselage consisting of a metallic substrate 10 (generally an aluminum alloy) optionally covered with a paint 11. A finish 12, consisting e.g. of a transparent varnish or paint composition compatible with the paint 11, is used to cover the airplane fuselage, including the place where labels are affixed. Examples of finishes 12 which may be mentioned are the AVIOX® range of products from AKZO-NOBEL, which include a “clearcoat” protective finishing varnish.

The layer of varnish 6 deposited on the marking device 1 is advantageously compatible with this finish 12 so that, when the marking device is affixed to the airplane fuselage, it can be covered with the finish 12 without there being any problems of rejection or reaction between the finish 12 and the layer of varnish 6 on the marking device. By virtue of the enhanced adhesion properties of the dulled carrier film 2, the layer 6 can be produced using the same varnish or a varnish from the same range as the finish 12.

The layer of varnish 6 can also consist of industrial varnish or transparent paint compositions for imparting specific properties to the upper surface of the marking device. For example, flexible varnishes can impart impact resistance properties to the marking device, whilst compositions with a high hardness, once they have completely polymerized, will impart scratch resistance properties. Yet other compositions make it possible to obtain soil or graffiti resistance properties. All these properties, which hitherto were obtainable only with a film coating applied subsequently to the marking device, because of the incompatibility of the majority of compositions with the existing ink systems, can now be obtained directly by virtue of the remarkable surface tension due to the dulling of the carrier film.

The layer of varnish 6 covers that part of the carrier film 2 which is not covered by the marking pattern 5, penetrates into the microroughnesses on the surface of the carrier film and restores a smooth, glossy surface condition to the marking device. In addition, as previously seen for the layer of adhesive 3, in the case of a transparent carrier film 2 the penetration of the varnish into the microroughnesses on the surface eliminates the milky appearance of the carrier film and renders it completely clear.

The layer of varnish 6 can be applied by screen printing to a surface corresponding to the finished marking device, i.e. leaving uncovered gaps between separate labels printed on the same plate, or else it can be applied to the whole plate by spraying.

Once the layer of varnish 6 is dry, a step S104 for cutting the various labels produced on the same plate is carried out by conventional means such as kiss-cutting the outline of each label.

Before or, preferably, after cutting, it may be useful to carry out an optional step for treating the external surface of the layer of protective varnish 6 in order further to improve the subsequent covering of the label with the finish 12. In this step, the surface of the varnish is mechanically or chemically dulled, for example, analogously to the dulling of the carrier film 2. Alternately or in combination, and preferably after the cutting step, this treatment can comprise cleaning of the external surface with a solvent, e.g. isopropyl alcohol, in order to remove any trace of surface contamination that might detract from the subsequent covering of the surface with the finish 12. Thus the surface condition of the outer side of the layer of protective varnish 6 is suitable for facilitating the adhesion of the finish 12 to the marking device.

Once the cutting has been done, the marking device is capable of being used. However, to facilitate its transfer to the exact place intended, it is advantageous to use a handling film 8, made e.g. of paper or semitransparent polyethylene, carrying a layer of glue 7 whose adhesive strength is greater than that of the layer of adhesive 3 on its protective sheet 4, but very much less than that of this same layer of adhesive on the substrate 10 or the paint 11 to which the marking device is to be stuck. The handling film 8 is then transferred to the plate of labels in a step S105 of the process for the production of the marking device.

In a variant of the marking device according to the invention, the marking pattern 5 and the layer of varnish 6 are replaced with a layer of paint applied directly to the carrier film 2 using a paint identical to the paint 11 used to cover the substrate 10 (airplane fuselage). It is thus possible to obtain self-adhesive sheets composed of a carrier film 2/layer of adhesive 3/protective sheet “composite” covered with a layer of paint whose shade is identical to that used for certain parts of the fuselage. It is thus possible to produce a marking by cutting a “positive” pattern out of this self-adhesive sheet, said marking replacing one obtained by painting with the same paint through a stencil cut out according to the same pattern as a “negative”. As the paint used on the carrier film is the same as that applied directly to the substrate, it will be compatible with the finish 12 applied on top. This variant of the marking device according to the invention makes it possible to obtain a marking on a first part of a contrasted two-colored surface using a paint whose shade is exactly the same as the color of the second part, in contrast to the bulk-colored self-adhesive films currently in use, whose shades do not always correspond.

Also in this variant it is possible to produce a unique decoration by painting directly on a composite sheet consisting of a carrier film 2 according to the invention and a layer of adhesive. Such a decoration is generally painted directly by the artist on the object to be decorated, whether it be an airplane fuselage, a vehicle body, or the like. This method involves immobilizing the object while the paint is applied and allowed to dry. By virtue of the marking device according to the invention, it is possible to apply this paint to the carrier film, including the steps for drying and protecting with the layer of varnish 6, and then affix it to the object in a shorter time. In this way the immobilization time required to decorate an airplane can be reduced from several days to a few hours, representing a considerable economic benefit.

1-20. (canceled)

21. An adhesive marking device (1) comprising a synthetic carrier film (2) carrying on a first side, called the upper side, at least one marking pattern (5) covered with a layer of protective varnish (6), and on a second side opposite the first, called the lower side, a layer of pressure-sensitive adhesive (3) protected by a protective sheet (4), wherein the carrier film (2) is a polyester film having a thickness of between 20 and 50 μm, both sides of which have a dulled surface condition whose roughness is appropriate for obtaining a surface energy of at least 58 mN/m according to standard ASTM D2578.

22. The marking device as claimed in claim 21 wherein the carrier film (2) is a transparent film of polyethylene terephthalate.

23. The marking device as claimed in claim 21 wherein the thickness of the layer of pressure-sensitive adhesive (3) is between one and three times that of the carrier film (2), the minimum thickness being 50 μm.

24. The marking device as claimed in claim 21 wherein the thickness of the layer of pressure-sensitive adhesive (3) is at least 100 μm, which is suitable for sticking said marking device (1) to textured surfaces.

25. The marking device as claimed in claim 21 wherein the carrier film (2) carries on its upper side a marking pattern (5) in direct contact with said film.

26. The marking device as claimed in claim 25 wherein the minimum adhesion between the marking pattern (5) and the carrier film (2) is at least 2.6 MPa according to standard ISO 4624.

27. The marking device as claimed in claim 21 wherein the marking pattern (5) and the upper side of the carrier film are covered with a layer of protective varnish (6), optically smoothing the upper side of the carrier film and acting technically as an interface with the external medium.

28. The marking device as claimed in claim 27 suitable for application to a substrate (10) which is to be covered with a finish (12) after application, wherein the protective varnish forming said layer (6) is compatible with this finish (12).

29. The marking device as claimed in claim 27 wherein the protective varnish is selected from a range of compositions which ensure, individually or in combination, that the external surface of the marking device has mechanical and/or chemical properties of resistance to graffiti, soil, scratching, abrasion, impact and chemicals, and/or antiskid properties.

30. The marking device as claimed in claim 27 suitable for application to a substrate (10) which is to be covered with a finish (12) after application, wherein the outer side of the layer of protective varnish (6) has a surface condition that is appropriate for facilitating the adhesion of the finish (12) to the marking device.

31. The marking device as claimed in claim 21 suitable for application to a substrate (10) which is to be covered with a paint (11), wherein the carrier film (2) is covered with a paint identical to said paint (11).

32. The marking device as claimed in claim 21 which also comprises a weakly adhesive handling film (8) stuck to its upper side.

33. A process for the production of a marking device as claimed in claim 21, wherein:
the chosen carrier film (2) is a polyester film having a thickness of between 20 and 50 μm, both sides of which have a dulled surface condition whose roughness is appropriate for obtaining a surface energy of at least 58 mN/m according to standard ASTM D2578,
a layer of adhesive (3) is applied (S101) to the lower side of the carrier film,
a marking pattern (5) is printed (S102) on the upper side of said carrier film (2),
the marking pattern (5) and the parts of the carrier film (2) that are not covered by it are covered (S103) with a layer of varnish (6),
the outline of the marking device is cut (S104), and
the varnish is covered (S105) with a semi-transparent handling film (8).

34. The process as claimed in claim 33 wherein the layer of adhesive (3) is applied by colaminating a film of acrylic glue and the dulled carrier film (2).

35. The process as claimed in claim 34 wherein, when the carrier film (2) is transparent, the lamination is carried out in a dust-free, controlled atmosphere.

36. The process as claimed in claim 33 wherein the marking pattern is printed by digital inkjet printing.

37. The process as claimed in claim 33 wherein the marking pattern is printed by screen printing.

38. The process as claimed in claim 33 wherein the step for covering the marking pattern and the carrier film with a layer of varnish is carried out by screen printing.

39. The process as claimed in claim 33 wherein the step for covering the marking pattern and the carrier film with a layer of varnish is carried out by spraying.

40. The process as claimed in claim 33 wherein a step for treating the external surface of the layer of varnish (6) is inserted before the step (S105) for covering the varnish with a handling film (8).
